(19) United States
(12) Patent Application Publication
(10) Pub. No.: US 2013/0088642 A1
(43) Pub. Date: Apr. 11, 2013

(54) VOICE CONTROLLING SYSTEM FOR ADJUSTING A VIDEO WALL

(71) Applicant: Chisen HSIEH, Taoyuan Hsien (TW)

(72) Inventor: Chisen HSIEH, Taoyuan Hsien (TW)

(73) Assignee: DELTA ELECTRONICS, INC., Taoyuan Hsien (TW)

(21) Appl. No.: 13/421,261

(22) Filed: Mar. 15, 2012

(30) Foreign Application Priority Data
Oct. 10, 2011 (CN) 201110321522.8

(51) Int. Cl. H04N 5/445; G10L 21/00; H04N 5/44

(52) U.S. Cl. 348/563; 348/734; 704/E21.001; 348/E05.096; 348/E05.099

(57) ABSTRACT

A voice controlling system for adjusting a video wall is provided. The video wall comprises a plurality of display apparatuses, and the voice controlling system comprises a wireless mobile apparatus and a controlling server. The controlling server connects with the video wall via a connection. The wireless mobile apparatus is configured to convert a voice command from a user into a controlling signal and to transmit the controlling signal to the controlling server via a wireless network. The controlling server is configured to adjust the display apparatuses of the video wall via the connection according to the controlling signal.

This application claims priority to Chinese Patent Application No. 201110321522.8 filed on Oct. 10, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a voice controlling system for adjusting a video wall. More particularly, the voice controlling system of the present invention adjusts display apparatuses of the video wall by means of a voice signal via a wireless network.

2. Descriptions of the Related Art

Conventional video wall technologies display a large image primarily by splicing a plurality of display apparatuses together. Because the plurality of display apparatuses are used to display a single image, how to adjust the individual display apparatuses respectively so that the single image is displayed on the video wall in a well-coordinated way becomes very essential for providing users with more comfortable watching experiences.

Specifically, because the video wall comprises a plurality of display apparatuses, differences in luminance and colors may arise between the individual display apparatuses when the display apparatuses have different service conditions. In this case, the individual display apparatuses must be adjusted respectively so that the single image can be displayed by the whole video wall in a well-coordinated way. Conventionally, the display apparatuses are adjusted mainly in a manual way. In detail, the most commonly adopted adjusting way is mainly as follows: the image displaying quality of the video wall is inspected by a user standing in front of the video wall, and when it is determined that a certain display apparatus must be adjusted in luminance or in colors, the display apparatus will be adjusted manually.

However, the users' demands are driving sizes of video walls to become larger gradually. The larger the size of a video wall is, the distance between the video wall and the user who is inspecting the image displaying quality of the video wall will be if a complete inspection is desired. Therefore, if a large-size video wall is still adjusted in the aforesaid manual way, the user will have to consume much time and labor in going back and forth between the video wall and the inspection site, which makes the efficiency of adjusting the video wall very low.

Accordingly, an urgent need exists in the art to provide a solution capable of adjusting display apparatuses of a large-size vide wall more efficiently.

### SUMMARY OF THE INVENTION

To solve the aforesaid problem associated with adjustment of a video wall, the present invention provides a voice controlling system for adjusting a video wall. According to the voice controlling system, a wireless mobile apparatus receives a voice command from a user and transmits the voice command via a wireless network to a controlling server connecting with display apparatuses of the video wall so that the controlling server adjusts the display apparatuses according to the voice command.

To achieve the aforesaid objective, the present invention provides a voice controlling system for adjusting a video wall. The video wall comprises a plurality of display apparatuses, and the voice controlling system comprises a wireless mobile apparatus and a controlling server. The wireless mobile apparatus is configured to receive a voice command from a user, and the controlling server connects with the video wall via a connection. The wireless mobile apparatus is configured to convert the voice command into a controlling signal and to transmit the controlling signal to the controlling server via a wireless network. The controlling server is configured to adjust the display apparatuses of the video wall via the connection according to the controlling signal.

To achieve the aforesaid objective, the present invention further provides a wireless mobile apparatus for adjusting a video wall. The video wall comprises a plurality of display apparatuses and connects with a controlling server via a connection. The wireless mobile apparatus comprises a voice receiver, a processing unit and a transceiver. The voice receiver is configured to receive a voice command from a user. The processing unit is configured to convert the voice command into a controlling signal. The transceiver is configured to transmit the controlling signal to the controlling server via a wireless network so that the controlling server adjusts the display apparatuses of the video wall via the connection according the controlling signal.

Furthermore, to achieve the aforesaid objective, the present invention also provides a controlling server for adjusting a video wall. The video wall comprises a plurality of display apparatuses and connects with a controlling server via a connection. The controlling server comprises a transceiver and a processing unit. The transceiver is configured to receive a controlling signal transmitted from a wireless mobile apparatus via a wireless network. The controlling signal is converted from a voice command of a user by the wireless mobile apparatus. The processing unit is configured to adjust the display apparatuses of the video wall via the connection according to the controlling signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating how a voice controlling system controls and adjusts a video wall according to a first embodiment of the present invention;

FIG. 1B is a schematic view of a wireless mobile apparatus according to the first embodiment of the present invention;

FIG. 1C is a schematic view of a controlling server according to the first embodiment of the present invention;

FIGS. 1D-1E are schematic views illustrating how an image displayed by a display apparatus of the video wall is adjusted according to the first embodiment of the present invention;

FIGS. 1F-1G are schematic views illustrating how a color displayed by the display apparatus of the video wall is adjusted according to the first embodiment of the present invention;

FIG. 2A is a schematic view illustrating how a voice controlling system controls and adjusts the video wall according to a second embodiment of the present invention; and

FIG. 2B is a schematic view of a wireless mobile apparatus according to the second embodiment of the present invention.

### DESCRIPTION OF THE PREFERRED EMBODIMENT

In the following descriptions, the present invention will be explained with reference to embodiments thereof However, these embodiments are not intended to limit the present invention to any specific environment, applications or particular implementations described in these embodiments. Therefore, description of these embodiments is only for purpose of illustration rather than to limit the present invention. It shall be appreciated that, in the following embodiments and the attached drawings, elements not directly related to the present invention are omitted from depiction; and dimensional relationships among individual elements in the attached drawings are illustrated only for ease of understanding but not to limit the actual scale.

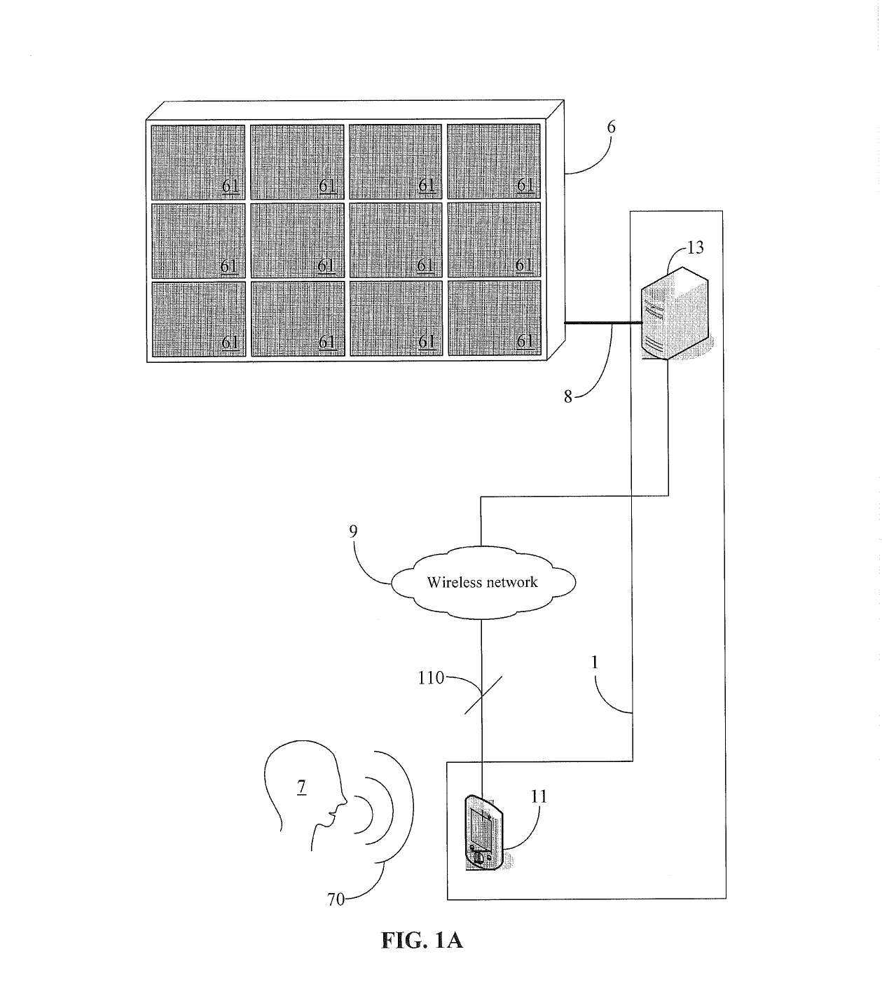

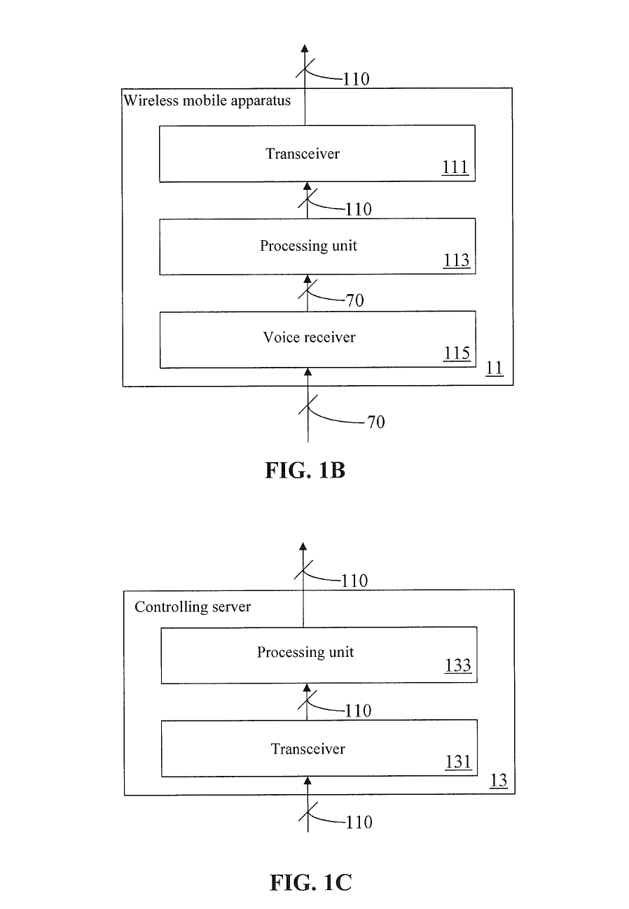

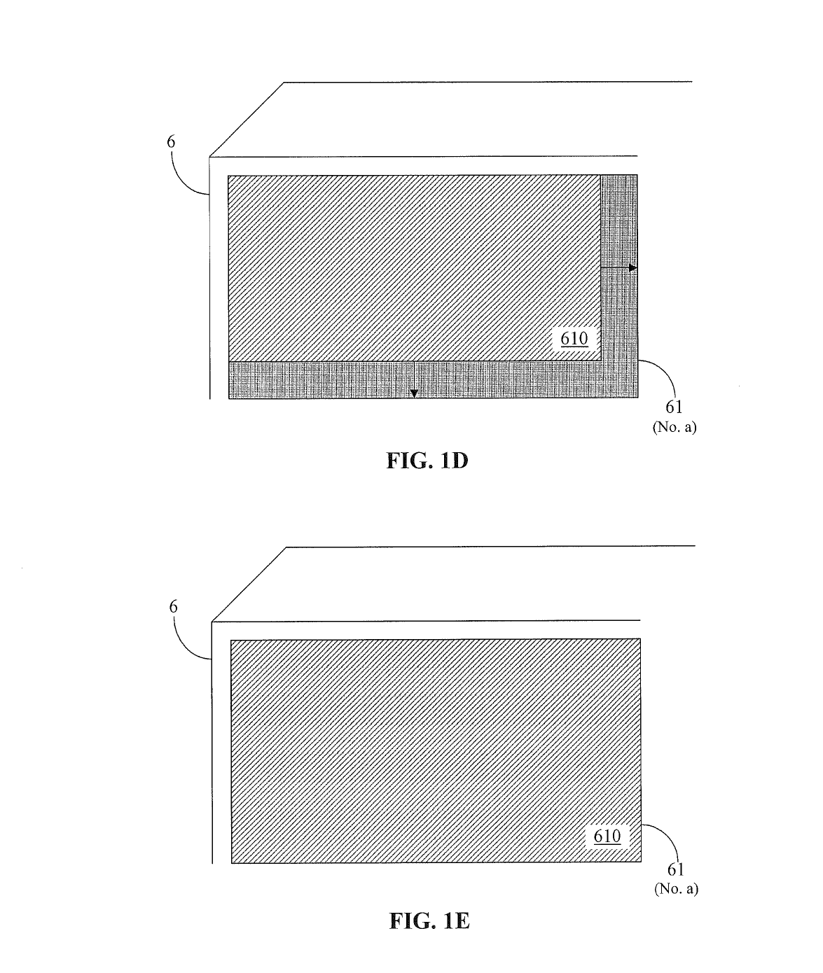

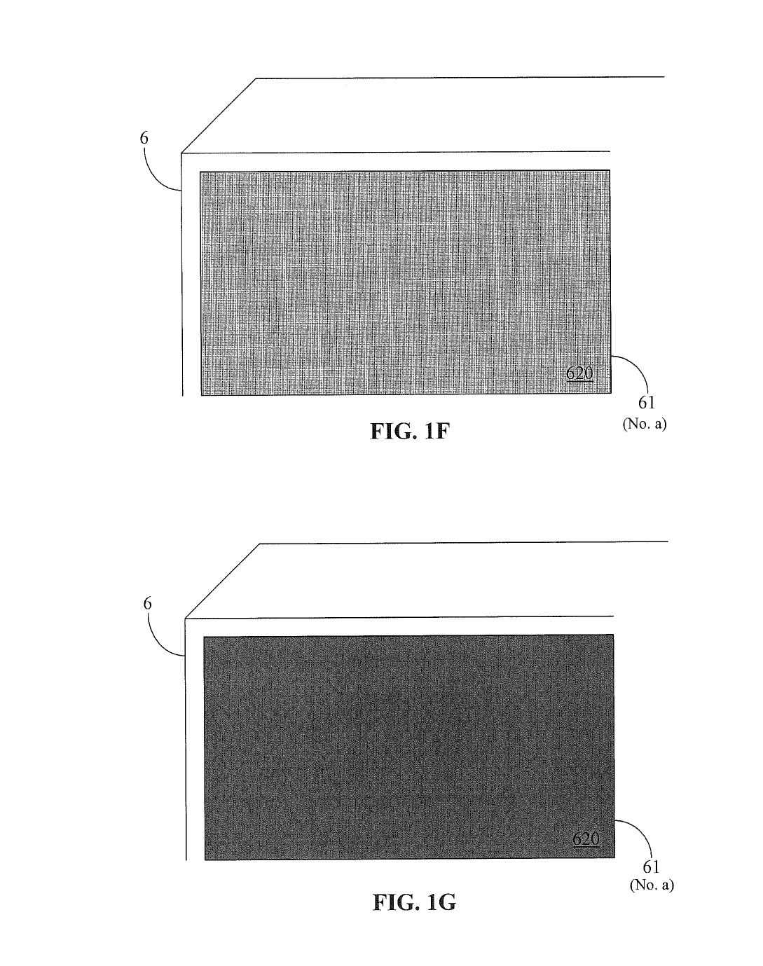

Firstly, please refer to FIG. 1A to FIG. 1C together. FIG. 1A is a schematic view illustrating how a voice controlling system 1 controls and adjusts a video wall 6 according to a first embodiment of the present invention. The video wall 6 comprises a plurality of display apparatuses 61, and the voice controlling system 1 comprises a wireless mobile apparatus 11 and a controlling server 13. The controlling server 13 connects with the video wall 6 via a connection 8, and the wireless mobile apparatus 11 communicates with the controlling server 13 via a wireless network 9. FIG. 1B is a schematic view of the wireless mobile apparatus 11 according to the first embodiment of the present invention. The wireless mobile apparatus 11 comprises a transceiver 111, a processing unit 113 and a voice receiver 115. FIG. 1C is a schematic view of the controlling server 13 according to the first embodiment of the present invention. The controlling server 13 comprises a transceiver 131 and a processing unit 133. It shall be particularly emphasized that, the wireless mobile apparatus 11 may be any apparatus having the calculation function such as a smartphone, a personal mobile assistant or a notebook computer; and the controlling server 13 may also be any computer having the calculation function. Interactions between these components will be described later.

In detail, when a user 7 desires to inspect the image quality of the video wall 6, the user 7 has to stand at a considerable distance from the video wall 6 to facilitate the inspection. Then, when it is determined that one of the display apparatuses 61 needs to be adjusted, the user 7 directly inputs a voice command 70 into the wireless mobile apparatus 11 so that the wireless mobile apparatus 11 can determine contents of the voice command 70 and convert the voice command 70 into a controlling signal 110. Subsequently, the wireless mobile apparatus 11 transmits the controlling signal 110 to the controlling server 13 via the wireless network 9 so that the controlling server 13 adjusts a displaying status of an assigned display apparatus 61 of the video wall 6 via the connection 8 according to the controlling signal 110.

In more detail, when the voice command 70 is inputted into the wireless mobile apparatus 11 by the user 7, the voice receiver 115 (e.g., a microphone module) of the wireless mobile apparatus 11 is configured to receive the voice command 70. Then, the processing unit 113 of the wireless mobile apparatus 11 determines an adjusting action that the user 7 desires to perform by identifying the voice according to the contents of the voice command 70, and converts the voice command 70 into a corresponding controlling signal 110 accordingly. Subsequently, the transceiver 111 of the wireless mobile apparatus 11 transmits the controlling signal 110 to the controlling server 13 via the wireless network 9. Afterwards, the transceiver 131 of the controlling server 13 receives the controlling signal 110 transmitted from the wireless mobile apparatus 11 via the wireless network 9, and the processing unit 133 of the controlling server 13 adjusts the displaying status of the assigned display apparatus 61 of the video wall 6 via the connection 8 according to the controlling signal 110.

It shall be particularly appreciated that, the processing unit 113 of the wireless mobile apparatus 11 may determine contents of the controlling signal 110 such as a piece of display apparatus assignation information and a piece of image coordinate information according to the voice command 70 so that the controlling server 13 can adjust an image displaying location of the assigned display apparatus accordingly. Referring to FIG. 1D and FIG. 1E together, there are shown schematic views illustrating how an image displayed by a display apparatus 61 of the video wall 6 is adjusted according to the first embodiment of the present invention. By way of example, assuming that a display apparatus 61 located at an upper-left corner of the video wall 6 has the display apparatus assignation information (i.e., No. a), then the user 7 may input the voice command 70 into the wireless mobile apparatus 11 if the user 7 desires to adjust a displaying location of an image 610 displayed by the display apparatus 61 located at the upper-left corner of the video wall 6. Here, the voice command 70 has the following contents: No. a, the X-coordinate value of the image needs to be increased by one unit and the Y-coordinate value of the image needs to be decreased by one unit.

Then, the wireless mobile apparatus 11 determines the controlling signal 110 according to the contents of the voice command 70. The controlling signal 110 comprises a piece of display apparatus assignation information (i.e., a piece of information indicating that the display apparatus 61 having the No. a needs to be adjusted) and a piece of image coordinate information (i.e., a piece of information indicating that the X-coordinate value of the image needs to be increased by one unit and the Y-coordinate value of the image needs to be decreased by one unit). Thus, after receiving the controlling signal 110, the controlling server 13 can adjust the displaying location of the image 610 in the display apparatus 61 (which has the No. a) of the video wall 6 according to the controlling signal 110.

Similarly, the processing unit 113 may determine the contents of the controlling signal 110 such as a piece of display apparatus assignation information and a piece of color information according to the voice command 70 so that the controlling server 13 can adjust a color of an image displayed by an assigned display apparatus accordingly. Referring to FIG. 1F and FIG. 1G together, there are shown schematic views illustrating how a color displayed by the display apparatus 61 of the video wall 6 is adjusted according to the first embodiment of the present invention. By way of example, also assuming that the display apparatus 61 located at the upper-left corner of the video wall 6 has a piece of display apparatus assignation information (i.e., the No. a), then the user 7 may input the voice command 70 into the wireless mobile apparatus 11 if the user 7 desires to adjust a color or luminance of an image 620 displayed by the display apparatus 61 located at the upper-left corner of the video wall 6. Here, the voice command 70 has the following contents: No. a, red luminance needs to be increased by one unit, green luminance needs to be increased by two units and blue luminance needs to be increased by one unit.

Then, the wireless mobile apparatus 11 determines the controlling signal 110 according to the contents of the voice command 70. The controlling signal 110 comprises a piece of display apparatus assignation information (i.e., a piece of information indicating that the display apparatus 61 having the No. a needs to be adjusted) and a piece of color information (i.e., units by which the color needs to be adjusted). Thus, after receiving the controlling signal 110, the controlling server 13 can adjust the color of the image 620 displayed by the display apparatus 61 (which has the No. a) of the video wall 6 according to the controlling signal 110.

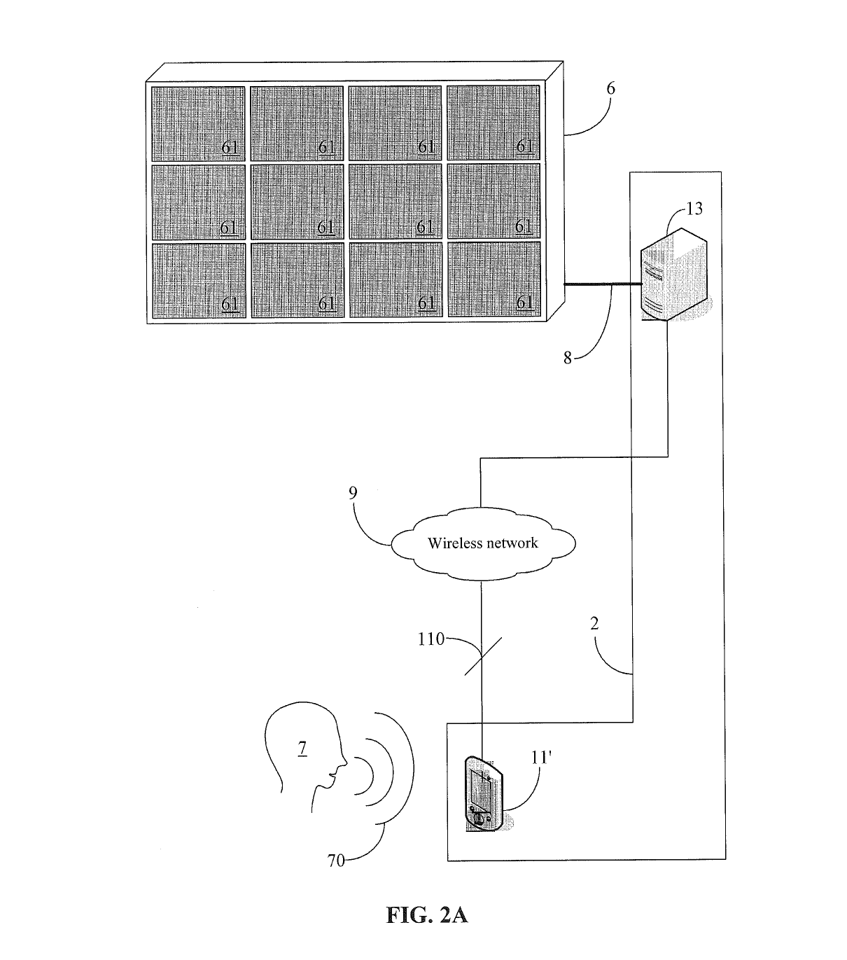

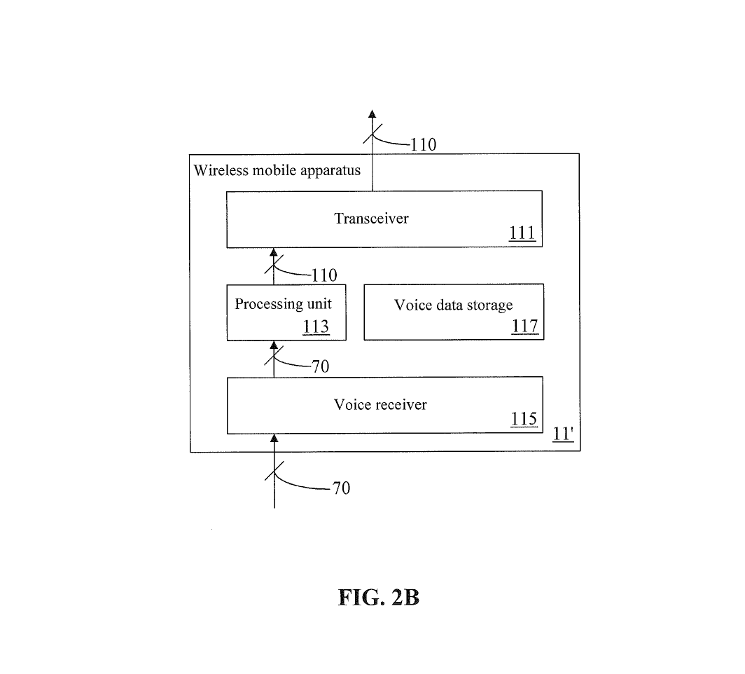

Next, referring to FIG. 2A and FIG. 2B, FIG. 2A is a schematic view illustrating how a voice controlling system 2 controls and adjusts the video wall 6 according to a second embodiment of the present invention, and FIG. 2B is a schematic view of a wireless mobile apparatus 11′ according to the second embodiment of the present invention. It shall be particularly appreciated that, functions and the operation process of the voice controlling system 2 according to the second embodiment are similar to those of the voice controlling system 1 according to the first embodiment and components bearing the same reference numerals have the same functions, so these will not be further described again herein. The difference between the second embodiment and the first embodiment is that the wireless mobile apparatus 11′ according to the second embodiment further comprises a voice data storage 117 which stores a plurality of pieces of voice identification information.

In detail, the voice data storage 117 of the wireless mobile apparatus 11′ in the second embodiment stores a plurality of pieces of voice identification information, which is substantially a voice database from which the contents of the voice command 70 are determined. Further speaking, the plurality of pieces of voice identification information stored in the voice data storage 117 comprises identification contents for various voice commands. After the voice command 70 is received, the processing unit 113 of the wireless mobile apparatus 11′ can determine a meaning that the voice command 70 represents according to the contents of the voice identification information so as to convert the voice command 70 into a corresponding controlling signal 110. In this way, by disposing the voice database in the voice data storage 117, the voice identification function of the voice controlling system 2 of the present invention can be used with higher flexibility.

According to the voice controlling system of the present invention, the wireless mobile apparatus receives the voice command from the user and converts the voice command into the controlling signal for transmission to the controlling server via the wireless network so that the controlling server adjusts the display apparatuses of the video wall. In this way, the user can inspect the video wall at a large distance conveniently and adjust the image by means of the wireless network and the voice command.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A voice controlling system for adjusting a video wall, the video wall comprising a plurality of display apparatuses, and the voice controlling system comprising:
a wireless mobile apparatus, being configured to receive a voice command from a user; and
a controlling server, connecting with the video wall via a connection,
wherein the wireless mobile apparatus is further configured to convert the voice command into a controlling signal and to transmit the controlling signal to the controlling server via a wireless network, and the controlling server is configured to adjust the display apparatuses of the video wall via the connection according to the controlling signal.

2. The voice controlling system of claim 1, wherein the wireless mobile apparatus further comprises a voice data storage which stores a plurality of pieces of voice identification information, and the wireless mobile apparatus is configured to convert the voice command into the controlling signal according to the voice identification information stored in the voice data storage.

3. The voice controlling system of claim 1, wherein the controlling signal comprises a piece of display apparatus assignation information and a piece of image coordinate information, and the controlling server is configured to adjust an image displaying location of an assigned display apparatus of the video wall according to the display apparatus assignation information and the image coordinate information of the controlling signal.

4. The voice controlling system of claim 1, wherein the controlling signal comprises a piece of display apparatus assignation information and a piece of color information, and the controlling server is configured to adjust a color of an assigned display apparatus of the video wall according to the display apparatus assignation information and the color information of the controlling signal.

5. A wireless mobile apparatus for adjusting a video wall, the video wall comprising a plurality of display apparatuses and connecting with a controlling server via a connection, and the wireless mobile apparatus comprising:
a voice receiver, being configured to receive a voice command from a user;
a processing unit, being configured to convert the voice command into a controlling signal; and
a transceiver, being configured to transmit the controlling signal to the controlling server via a wireless network so that the controlling server adjusts the display apparatuses of the video wall via the connection according the controlling signal.

6. The wireless mobile apparatus of claim 5, wherein the wireless mobile apparatus further comprises a voice data storage which stores a plurality of pieces of voice identification information, and the processing unit is configured to convert the voice command into the controlling signal according the voice identification information stored in the voice data storage.

7. The wireless mobile apparatus of claim 5, wherein the controlling signal comprises a piece of display apparatus assignation information and a piece of image coordinate information, and the transceiver is configured to transmit the controlling signal, which comprises the display apparatus assignation information and the image coordinate information, to the controlling server so that the controlling server adjusts an image displaying location of an assigned display apparatus of the video wall according to the display apparatus assignation information and the image coordinate information of the controlling signal.

8. The wireless mobile apparatus of claim 5, wherein the controlling signal comprises a piece of display apparatus assignation information and a piece of color information, and the transceiver is configured to transmit the controlling signal, which comprises the display apparatus assignation information and the color information to the controlling server so that the controlling server adjusts a color of an assigned display apparatus of the video wall according to the display apparatus assignation information and the color information of the controlling signal.

9. A controlling server for adjusting a video wall, the video wall comprising a plurality of display apparatuses and connecting with the controlling server via a connection, and the controlling server comprising:
a transceiver, being configured to receive a controlling signal transmitted from a wireless mobile apparatus via a wireless network, wherein the controlling signal is converted from a voice command of a user by the wireless mobile apparatus; and
a processing unit, being configured to adjust the display apparatuses of the video wall via the connection according to the controlling signal.

10. The controlling server of claim 9, wherein the controlling signal comprises a piece of display apparatus assignation information and a piece of image coordinate information, the transceiver is configured to receive the controlling signal, which comprises the display apparatus assignation information and the image coordinate information, and the processing unit is configured to adjust an image displaying location of an assigned display apparatus of the video wall according to the display apparatus assignation information and the image coordinate information of the controlling signal.

11. The controlling server of claim 9, wherein the controlling signal comprises a piece of display apparatus assignation information and a piece of color information, the transceiver is configured to receive the controlling signal, which comprises the display apparatus assignation information and the color information, and the processing unit is configured to adjust a color of an assigned display apparatus of the video wall according to the display apparatus assignation information and the color information of the controlling signal.
